(19) United States
(12) Patent Application Publication
(10) Pub. No.: US 2022/0017736 A1
(43) Pub. Date: Jan. 20, 2022

(54) CURABLE COMPOSITION

(71) Applicant: SOLVAY SPECIALTY POLYMERS ITALY S.P.A., Bollate (IT)

(72) Inventors: Aldo SANGUINETI, Milano (IT); Marco MIRENDA, Rho (IT); Ivan Diego WLASSICS, Garessio (IT)

(21) Appl. No.: 17/311,023

(22) PCT Filed: Dec. 16, 2019
(86) PCT No.: PCT/EP2019/085434

§ 371 Date: Jun. 4, 2021

(30) Foreign Application Priority Data
Dec. 19, 2018 (EP) 18213892.5

(51) Int. Cl. C08L 27/18; C08L 81/02; C08G 65/26; C08L 27/10; C08K 3/22; C08K 5/00; C08K 5/03; C08K 5/14

(52) U.S. Cl. CPC C08L 27/18; C08L 2312/00; C08G 65/2612; C08L 27/10; C08K 3/22; C08K 5/0025; C08K 5/03; C08K 5/14; C08L 2205/025; C08L 2205/22; C08L 2207/04; C08G 2650/40; C08K 2003/222; C08L 2310/00; C08L 81/02

(57) ABSTRACT

The present invention relates to a curable composition comprising: at least one polymer comprising cure sites [polymer (E)], at least one thermoplastic polymer [thermoplastic (P)] different from said polymer (E) and at least one 1,5 enediyne curing agent [agent (C)], and to a blend obtained by dynamic vulcanization of said composition.

### CROSS REFERENCE TO RELATED APPLICATIONS

This application claims priority to European patent application No. 18213892.5 filed on Dec. 19, 2018, the whole content of this application being incorporated herein by reference for all purposes.

### TECHNICAL FIELD

The present invention relates to a curable composition and to a blend obtained by dynamic curing of said composition.

### BACKGROUND ART

Thermoplastic vulcanizates (TPV) are two-phase compositions comprising a thermoplastic material as continuous phase and an elastomeric material as dispersed phase, produced by simultaneous mixing the two materials and cross-linking the elastomeric one while keeping the thermoplastic in the molten state. Typically, the elastomeric material forms cross-linked particles uniformly dispersed in the thermoplastic. Said process is well known as dynamic vulcanization.

These materials are particularly advantageous in that they derive their rubber-like properties from the dispersed phase, so that they can be notably used in all rubber-typical fields of use (sealing articles, including seals and gaskets, pipes, hoses, flat sheets, and the like), while being processable as thermoplastics, including possibility of reforming scraps, flashes or defective parts.

In blends of two or more thermoplastic materials, dynamic vulcanization of one or more thermoplastic materials is also advantageously used to stabilize the disperse phase in order to avoid particles coalescence and phase separation during subsequent processing of the blend and, if the reaction involves more than one component, to promote compatibilization of the different components of the blends.

Dynamic vulcanization allows to prepare materials which are melt processable despite one phase is cross-linked, as the non-crosslinked component remains continuous even at high concentration. This approach is normally applied to prepare TPVs with a high content of elastomeric phase.

Several curing systems are employed to cross-link fluorinated polymers. For instance, peroxide-based cross-linking systems, ionic-based cross-linking systems or nitrile-based cross-linking systems are notably used for curing elastomers. More in particular, the peroxide-based systems generally comprise at least one organic peroxide (e.g. 5-bis(tert-butylperoxy)-2,5-dimethylhexane) and at least one polyunsaturated co-agent (e.g. 1,3,5-triallyl-1,3,5-triazine-2,4,6(1H,3H,5H)-trione).

However, the cross-linking systems known in the art for curing fluorinated polymers have issues when used in the dynamic vulcanization in a thermoplastic matrix requiring high processing temperatures, in particular temperatures higher than 300° C. Examples of thermoplastics requiring processing temperatures above 300° C. are notably copolymers of tetrafluoroethylene (TFE) and aromatic polymers like poly(p-phenylene sulphide) (PPS). Actually, organic peroxides contained in said cross-linking systems generally possess decomposition temperatures well below 300° C. As a consequence, organic peroxides decompose at temperatures much lower than the required temperature of processing and a significant amount of radical species required for the cross-linking activation is effectively generated well below said temperature of processing. Accordingly, in the presence of said organic peroxides, significant cross-linking may occur in the heating phase, i.e. well before the thermoplastic polymer is actually melted, thus hindering the effective dynamic vulcanization leading to an optimum dispersion of the dispersed phase in the thermoplastic matrix.

Need is therefore felt to provide for a curable composition based on a high processing temperature thermoplastic, able to deliver a blend having a broad temperature range of application and possessing outstanding mechanical properties even at high temperature.

### SUMMARY OF INVENTION

In a first aspect, the present invention relates to a curable composition comprising:
(a) at least one polymer comprising cure sites [polymer (E)],
(b) at least one thermoplastic polymer [thermoplastic (P)] different from said polymer (E), and
(c) at least one curing agent [agent (C)] of formula (I):

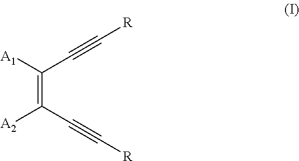

wherein:
each R, equal to or different from each other, is independently selected from the group consisting of hydrogen; halogen; C₁-C₂₀ alkyl, linear or branched, optionally substituted and/or optionally fluorinated; C₁-C₂₀ oxyalkyl, linear or branched, optionally substituted and/or optionally fluorinated; (per)fluoropolyether chain; aromatic or heteroaromatic radical, monocyclic or polycyclic, optionally substituted and/or optionally fluorinated; —SiR¹₃, —(R¹₂SiO)_{b}R¹, —PR¹₂ wherein each R¹, equal to or different from each other, is independently selected from the group consisting of hydrogen, C₁-C₂₀ alkyl, linear or branched, optionally substituted and/or optionally fluorinated and wherein b is an integer of at least 1; and

A₁ and A₂, equal to or different from each other, are each independently selected from the group consisting of hydrogen; halogen; C₁-C₂₀ alkyl, linear or branched, optionally substituted and/or optionally fluorinated; C₁-C₂₀ oxyalkyl, linear or branched, optionally substituted and/or optionally fluorinated; (per)fluoropolyether chain; —(R¹₂SiO)_{b}R¹ wherein R¹ and b are as defined; aromatic or heteroaromatic radical, monocyclic or polycyclic, optionally substituted and/or optionally fluorinated; A, and A₂ being preferably comprised in an aliphatic or aromatic cyclic structure, optionally substituted and/or optionally fluorinated.

In a second aspect, the present invention relates to a method for manufacturing the above curable composition, said method comprising at least one step of mixing said at least one polymer (E), said at least one agent (C) and said at least one thermoplastic (P).

In a third aspect, the present invention relates to a method for manufacturing a blend comprising a continuous thermoplastic polymer phase and a dispersed vulcanized polymer phase, said method comprising dynamic vulcanization of the curable composition identified above.

Further, the present invention relates to a blend comprising a continuous thermoplastic polymer phase and a dispersed vulcanized polymer phase, the blend being obtained by the above defined method.

In another aspect, the present invention relates to a method for manufacturing a shaped article, said method comprising moulding said blend.

The Applicant has surprisingly found that the curing agents of formula (I) are effective in generating radical species at high temperatures, even above 350° C., and therefore they can be used in dynamic vulcanization at such temperatures, thus allowing the use of high processing temperature thermoplastic polymers. Furthermore, the Applicant has surprisingly found that the curing agents of formula (I) are also suitable to be used within the short residence times of reactive extrusion, which is typically used to carry out the dynamic vulcanization.

### BRIEF DESCRIPTION OF THE DRAWINGS

FIG. 1 shows the images from the photographic analysis of a blend comprising MFA 640 and the masterbatch A according to Example 1 (E1) and of a blend comprising MFA 640 and the masterbatch B according to Comparative Example 4 (CE4).

FIG. 2 shows the SEM micrograph of a blend comprising MFA 640 and the masterbatch A according to Example 1 (E1).

FIG. 3 shows the SEM micrograph of a blend comprising MFA 640 and the masterbatch B according to Comparative Example 4 (CE4).

### DESCRIPTION OF EMBODIMENTS

In the present description, unless otherwise indicated, the following terms are to be meant as follows.

The term “cure site” is intended to indicate a point susceptible to chemical attack/reaction.

The term “(per)fluoropolymer” is intended to denote a fully or partially fluorinated polymer, comprising recurring units derived from at least one ethylenically unsaturated monomer comprising at least one fluorine atom (hereafter, (per)fluorinated monomer (F)) and, optionally, recurring units derived from at least one ethylenically unsaturated monomer free from fluorine atoms (hereafter, hydrogenated monomer (M)).

The term “(per)fluoroelastomer” is intended to indicate a fully or partially fluorinated elastomer, in particular comprising more than 10% (wt), preferably more than 30% (wt), of recurring units derived from at least one (per)fluorinated monomer (F) and, optionally, recurring units derived from at least one hydrogenated monomer (M).

The term “elastomer” is intended to designate an amorphous product or a product having a low degree of crystallinity (crystalline phase less than 20% by volume), said product possessing a heat of fusion (ΔH_{f}) of less than 10 J/g, preferably less than 5 J/g, more preferably less than 2.5 J/g, and a glass transition temperature (T_{g}) below 10° C., preferably below 5° C., more preferably below 0° C. Heat of fusion (ΔH_{f}) and glass transition temperature (T_{g}) are determined according to ASTM D3418.

The term “thermoplastic” is intended to denote a polymer which softens on heating and hardens on cooling at room temperature, which at room temperature exists below its glass transition temperature if fully amorphous or below its melting point if semi-crystalline. It is nevertheless generally preferred for said polymer to be semi-crystalline, which is to say to have a definite melting point; preferred polymers are those possessing a heat of fusion (ΔH_{f}) of at least 10 J/g, preferably of at least 25 J/g, more preferably of at least 30 J/g, when determined according to ASTM D3418. Without upper limit for heat of fusion being critical, it is nevertheless understood that said polymer will generally possess a heat of fusion of at most 80 J/g, preferably of at most 60 J/g, more preferably of at most 40 J/g.

In the present description, the use of parentheses “( . . . )” before and after the names of compounds, symbols or numbers identifying formulae or parts of formulae like, for example, “polymer (E)” and “thermoplastic (P)”, has the mere purpose of better distinguishing those names, symbols or numbers from the remaining text; thus, said parentheses could also be omitted.

Curing Agent (C)

As said, the curable composition according to the invention comprises at least one curing agent of formula (I) above.

The ethynyl groups on adjacent carbon atoms in formula (I) are known to dimerize upon application of heat to form an aromatic ring having a 1,4-diradical. While not being bound by theory, it is believed that the 1,4-diradical may promote the cross-linking or curing process via a Bergman cyclization reaction such as the one disclosed by Warner et al. in Science, 268, (1995), pp. 814-816.

The nature of each R group in formula (I) is not particularly critical to the invention; however, the size of the R groups may, due to steric hindrance, undesirably interfere with the dimerization reaction of the ethynyl groups. In general, any R group which does not prevent the formation of a 1,4-diradical from the reaction of the ethynyl groups upon thermal treatment can be used in the compounds of formula (I).

Each R group is preferably selected among: hydrogen; halogen; C₁-C₈ alkyl, linear or branched, optionally substituted and/or optionally fluorinated (e.g. —CH₃, —C(CH₃)₃, —CF₃, —C₂F₅, —C₃F₇); C₁-C₃ oxyalkyl, linear or branched, optionally substituted and/or optionally fluorinated (e.g. —OCH₃, —OCF₃); (per)fluoropolyether chain; —(R¹₂SiO)_{b}R¹ wherein b and R¹ are as defined above; aromatic or heteroaromatic radical, monocyclic or polycyclic, optionally substituted and/or optionally fluorinated.

When aromatic, each R group preferably has from 6 to 15 carbon atoms, more preferably from 6 to 10 carbon atoms. When aromatic, R is preferably an unsubstituted or substituted phenyl group, e.g. a phenyl substituted with one or more fluorine atoms or with a C₁-C₆ alkyl or oxyalkyl group optionally fluorinated, e.g. —CH₃, —CF₃, —OCH₃, —OCF₃. Even more preferably, when aromatic, R is an unsubstituted phenyl group.

Each R group may be a (per)fluoropolyether chain. Suitable (per)fluoropolyether chains may be represented by formula —R_{F}—O_{Z}-T wherein: T is selected from a fluorine atom, a chlorine atom and a C₁-C₃ (per)fluoroalkyl group comprising, optionally, one or more hydrogen or chlorine atoms; z is equal to 0 or 1; and R_{F} is a divalent (per)fluoropolyether radical selected from the following:
—(CF₂CF₂O)ₚ(CF₂O)_{q}—, wherein: p and q are integer numbers such that the q/p ratio is between 0.2 and 4, p being different from zero;
—(CF₂CF(CF₃)O)ᵣ(CF₂CF₂O)ₛ—(CFX₀O)ₜ—, wherein: X₀ is a fluorine atom or —CF₃; r and s are integer numbers such that t+s is between 1 and 50, the t/(r+s) ratio is between 0.01 and 0.05, (r+s) being different from zero;
—(CF(CF₃)CF₂O)ᵤ—R′_{f}O—(CF(CF₃)CF₂O)ᵤ—, wherein: R′_{f} is a C₁-C₃ bifunctional perfluoroalkyl radical; u is an integer of at least one;
—(CFX₀O)ₜ—(CF₂CF(CF₃)O)ᵣR′_{f}O—(CF₂CF(CF₃)O)ᵣ—(CFX₀O)ₜ—; wherein: R′_{f}, r, t and X₀ are as above;
—(CF₂(CF₂)ₓCF₂O)ᵥ—, wherein: v is an integer of at least one, x is an integer equal to 1 or 2;
—(CF₂CF₂CH₂O)_{w}—R′_{f}O—(CH₂CF₂CF₂O)_{w}—, wherein: R′_{f} is as above; w is an integer of at least one.

Typically p, q, r, s, t, u, v, w and x in the formulas above are selected so that the number average molecular weight of the (per)fluoropolyether radical R_{F} is between 500 and 10,000, preferably between 800 and 5000.

Preferably, A₁ and A₂ are part of an optionally substituted aliphatic or aromatic cyclic structure having from 5 to 10 carbon atoms, such as:

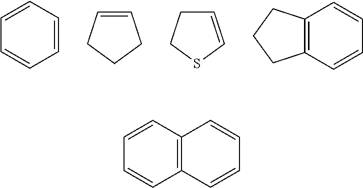

When A₁ and A₂ are part of an aliphatic or aromatic cyclic structure, said structure may be substituted on any of the carbon atoms.

A₁ and A₂ are preferably part of an aromatic cyclic structure, more preferably of an aromatic cyclic structure having from 6 to 10 carbon atoms, even more preferably of an unsubstituted or substituted phenyl ring.

Representative examples of compounds of formula (I) include but are not limited to:

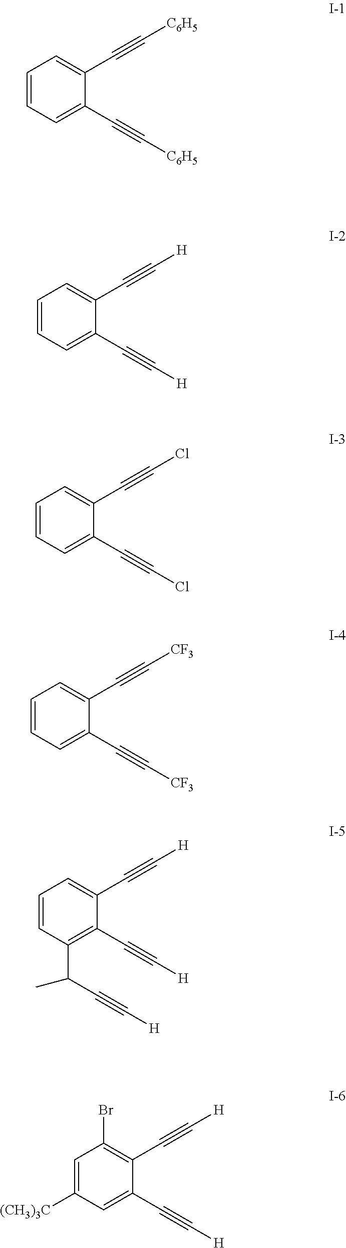

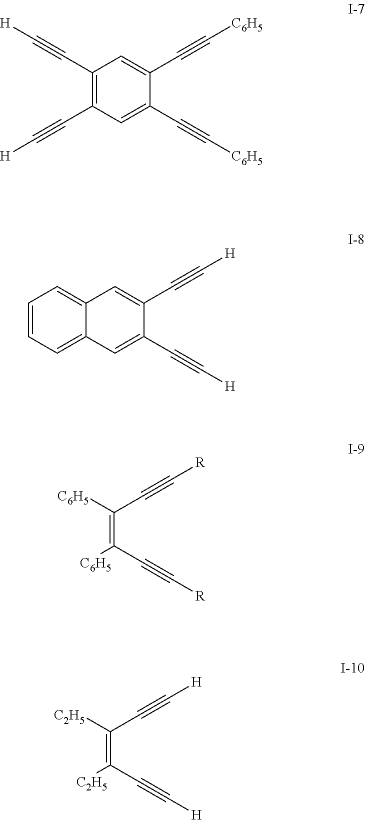

Preferably, A1 and A2 comprise a 1,5 enediyne moiety.

According to a preferred embodiment, said curing agent has formula (II) herein below:

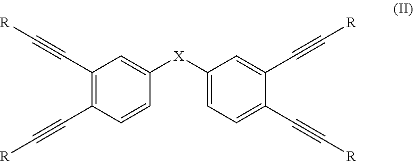

wherein:
each R, equal to or different from each other, is as defined above;

X is a divalent bridging group selected from a carbon-carbon bond; a C₁-C₂₀alkylene radical, optionally substituted (e.g. —C(CH₃)₂—) and/or optionally fluorinated (e.g. —(CF₂)ₙ—, —C(CF₃)₂—); a divalent (per)fluoropolyether radical R_{F} as defined above; an organopolysiloxane radical —(R¹₂SiO)_{b}— wherein R¹ and b are as defined above; a —O— radical; a —S— radical; a —SO₂— radical; a —C(O)— radical; a fused aromatic or heteroaromatic structure optionally substituted and/or optionally fluorinated.

More preferably X is selected from a C₁-C₂₀ fluorinated alkylene radical, optionally substituted, or a divalent (per)fluoropolyether radical R_{F} as above defined. Suitable C₁-C₂₀ fluorinated alkylene radicals are for instance —C(CF₃)₂— or those of formula —(CF₂)ₙ— wherein n is an integer from 1 to 20, e.g. 2, 3, 4, 6, 8, 10, 12, 14, 16, 18, 20.

Representative examples of compounds of formula (II) include but are not limited to:

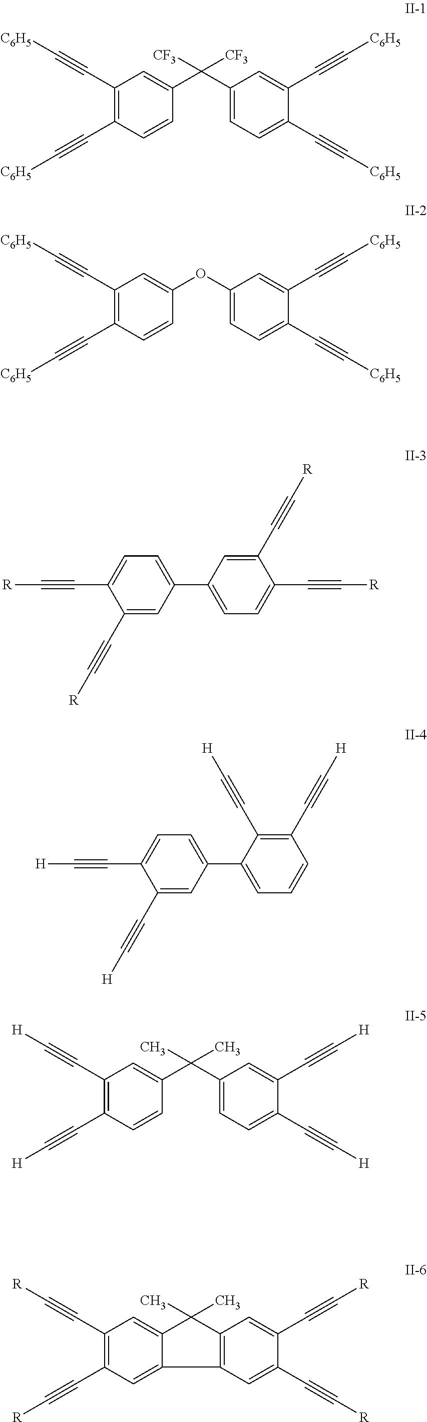

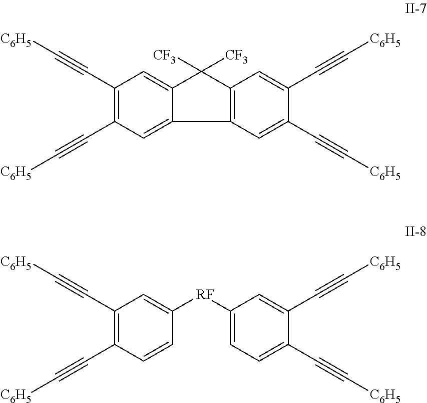

Compounds of formula (I) or (II) can be prepared according to known processes such as those described in Smith, D. W., Babb, D. A.; J. Am Chem. Soc. 120, n. 35, (1998) 9078-9079 or in Basak, A., Mandal, S., Bag, S. S.; Chemical Rev. 103, (2003) 4077-4094.

Polymer Comprising Cure Sites [Polymer (E)]

Polymer (E) may be any polymer which is suitable to be cross-linked, preferably suitable to be cross-linked with a radical initiated mechanism. Typically, polymers that may be cross-linked by a radical route comprise cure sites in their backbone, either provided by suitable functional groups present in recurring units from functional monomers incorporated in the polymer chain or provided by reactive end-groups, e.g. formed by suitable chain transfer agents (e.g. halogen-containing cure-sites). The term “backbone” is intended to indicate the longest series of covalently bonded atoms that together create a continuous chain.

Preferably, said polymer (E) comprises at least one of chlorine, iodine and bromine cure site in an amount such that its content ranges between 0.001 and 10% (wt), with respect to the total weight of the polymer (E). Iodine and bromine cure sites are preferred because they maximize the curing rate. For ensuring acceptable reactivity, the content of iodine and/or bromine in the polymer (E) should be of at least 0.05% (wt), preferably of at least 0.1% (wt), more preferably of at least 0.15% (wt), with respect to the total weight of the polymer (E). On the other side, amounts of iodine and/or bromine preferably not exceeding 7% (wt), more specifically not exceeding 5% (wt), or even not exceeding 4% (wt), with respect to the total weight of the polymer (E), are generally selected for avoiding side reactions and/or detrimental effects on thermal stability.

According to an embodiment, said iodine and/or bromine cure sites are comprised as pending groups bound to the backbone of the polymer chain.

The introduction of these iodine and/or bromine cure sites may be performed by adding, during manufacture of the polymer (E), brominated and/or iodinated comonomers, otherwise called brominated and/or iodinated cure-site comonomers. Non limitative examples of said brominated and/or iodinated cure-site comonomers are notably:
C₂-C₁ bromine- and/or iodine-containing olefins, i.e. olefins in which at least one hydrogen atom has been replaced with a bromine atom or an iodine atom, respectively, and optionally, one or more of the remaining hydrogen atoms have been replaced with an atom of another halogen, preferably fluorine. Representative suitable bromine-containing olefins include bromotrifluoroethylene, 1-bromo-2,2-difluoroethylene, 4-bromo-3,3,4,4-tetrafluorobutene-1, vinyl bromide, 1-bromo-1,2,2-trifluoroethylene, perfluoroallyl bromide, 4-bromo-1,1,2-trifluorobutene, 4-bromo-1,1,3,3,4,4-hexafluorobutene, 4-bromo-3-chloro-1,1,3,4,4-pentafluorobutene, 6-bromo-5,5,6,6-tetrafluoro-hexene, 4-bromo-perfluorobutene-1, and 3,3-difluoroallylbromide. Representative suitable iodine-containing olefins include compounds of the formula CH₂═CH(CF₂)ₓI where x is 2-6, more specifically, iodoethylene, 3-chloro-4-iodo-3,4,4-trifluorobutene, 2-iodo-1,1,2,2-tetrafluoro-1-(vinyloxy)ethane, 2-iodo-1-(perfluorovinyloxy)-1,1,-2,2-tetrafluoroethylene, 1,1,2,3,3,3-hexafluoro-2-iodo-1-(perfluorovinyloxy)propane, 2-iodoethyl vinyl ether, 3,3,4,5,5,5-hexafluoro-4-iodopentene, iodotrifluoroethylene, and preferably 4-iodo-3,3,4,4-tetrafluorobutene-1;
iodo- and/or bromo-containing fluorinated vinyl ethers; a preferred class of these compound is notably that complying with formula CF₂═CF—O—R′_{f}—CX₂Z, wherein each of X, equal to or different from each other is H or F, Z is I or Br, and R′_{f} is a divalent fluorocarbon group, preferably a —(CF₂)ₘ— group, with m=0 to 5.

As an alternative to or in combination with above mentioned iodine and/or bromine cure sites, said polymer (E) may comprise iodine and/or bromine atoms as terminal groups of the backbone of the polymer chain. These iodine and/or bromine atoms are typically introduced during manufacture of polymer (E), by polymerizing in the presence of iodinated and/or brominated chain-transfer agents. Among said chain-transfer agents mention can be made of: (i) alkali metal or alkaline-earth metal iodides and/or bromides, and (ii) iodine and/or bromine containing fluorocarbon compounds. In this view, preferred iodinated and/or brominated chain-transfer agents are those of formula R_{f}(I)ₓ(Br)_{y}, where R_{f} is a (per)fluoroalkyl or a (per)fluorochloroalkyl containing from 1 to 8 carbon atoms, while x and y are integers between 0 and 2, with 1≤x+y≤2. The use of these compounds is for instance described in U.S. Pat. No. 4,243,770 (DAIKIN IND LTD) 6 Jan. 1981 and U.S. Pat. No. 4,943,622 (NIPPON MEKTRON KK [JP]) 24 Jul. 1990.

Suitable polymers (E) may be hydrocarbon polymers or (per)fluoropolymers.

Notable examples of hydrocarbon polymers are for instance ethylene copolymers, ethylene/propylene/diene copolymers (e.g EPDM), styrene-butadiene copolymers, poly(butylene), chlorinated rubber, chlorinated ethylene polymers and copolymers, aromatic polymers comprising sulfone or sulfide bridging groups such as polyphenylenesulfide, polysulfone, polyethersulfone, polyphenylsulfone.

Preferably, polymer (E) is a (per)fluoropolymer. As said, a (per)fluoropolymer comprises recurring units derived from at least one (per)fluorinated monomer (F).

Preferably, said (per)fluorinated monomer (F) is selected from the group consisting of:
C₂-C₈ fluoro- and/or perfluoroolefins, such as tetrafluoroethylene (TFE), hexafluoropropene (HFP), pentafluoropropylene, and hexafluoroisobutylene;
C₂-C₈ hydrogenated monofluoroolefins, such as vinyl fluoride;
1,2-difluoroethylene, vinylidene fluoride (VDF) and trifluoroethylene (TrFE);
(per)fluoroalkylethylenes complying with formula CH₂═CH—R_{f0}, in which R_{f0} is a C₁-C₆ (per)fluoroalkyl or a C₁-C₆ (per)fluorooxyalkyl having one or more ether groups;
chloro- and/or bromo- and/or iodo-C₂-C₆ fluoroolefins, like chlorotrifluoroethylene (CTFE);
fluoroalkylvinylethers complying with formula CF₂═CFOR_{f1} in which R_{f1} is a C₁-C₆ fluoro- or perfluoroalkyl, e.g. —CF₃, —C₂F₅, —C₃F₇;
hydrofluoroalkylvinylethers complying with formula CH₂═CFOR_{f1} in which R_{f}, is a C₁-C₆ fluoro- or perfluoroalkyl, e.g. —CF₃, —C₂F₅, —C₃F₇;
fluoro-oxyalkylvinylethers complying with formula CF₂═CFOX₀, in which X₀ is a C₁-C₁₂ oxyalkyl, or a C₁-C₁₂ (per)fluorooxyalkyl having one or more ether groups; in particular (per)fluoro-methoxy-vinylethers complying with formula CF₂═CFOCF₂OR_{f2} in which R_{f2} is a C₁-C₆ fluoro- or perfluoroalkyl, e.g. —CF₃, —C₂F₅, —C₃F₇ or a C₁-C₆ (per)fluorooxyalkyl having one or more ether groups, like —C₂F₅—O—CF₃;
functional fluoro-alkylvinylethers complying with formula CF₂═CFOY₀, in which Y₀ is a C₁-C₁₂ alkyl or (per)fluoroalkyl, or a C₁-C₁₂ oxyalkyl or a C₁-C₁₂ (per)fluorooxyalkyl, said Y₀ group comprising a carboxylic or sulfonic acid group, in its acid, acid halide or salt form;
(per)fluorodioxoles, of formula:

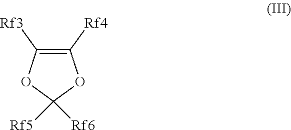

wherein each of R_{f3}, R_{f4}, R_{f5}, R_{f6}, equal to or different from each other, is independently a fluorine atom, a C₁-C₆ fluoro- or per(halo)fluoroalkyl, optionally comprising one or more than one oxygen atom, such as notably e.g. —CF₃, —C₂F₅, —C₃F₇, —OCF₃, —OCF₂CF₂OCF₃.

In addition to (per)fluorinated monomers (F), polymer (E) may also comprise hydrogenated monomers (M), such as ethylene and propylene.

### First Embodiment

In a first embodiment, said at least one polymer (E) is a (per)fluoroelastomer. For the sake of brevity, said (per)fluoroelastomer will be also referred to as elastomer (E1).

As said, in addition to recurring units derived from at least one (per)fluorinated monomer (F) selected from the group identified above, the elastomer (E1) may also comprise recurring units derived from at least one hydrogenated monomer (M). Examples of hydrogenated monomers (M) are notably hydrogenated alpha-olefins, including ethylene, propylene, 1-butene, diene monomers, styrene monomers, alpha-olefins being typically used.

Preferably, the elastomer (E1) is selected among:

(1) VDF-based copolymers, in which VDF is copolymerized with at least one additional comonomer selected from the group consisting of:

(a) C₂-C₈ perfluoroolefins, such as tetrafluoroethylene (TFE), hexafluoropropylene (HFP);

(b) hydrogen-containing C₂-C₈ olefins, such as vinyl fluoride (VF), trifluoroethylene (TrFE), hexafluoroisobutene (HFIB), perfluoroalkyl ethylenes of formula CH₂═CH—R_{f}, wherein R_{f} is a C₁-C₆ perfluoroalkyl group;

(c) C₂-C₈ fluoroolefins comprising at least one of iodine, chlorine and bromine, such as chlorotrifluoroethylene (CTFE);

(d) (per)fluoroalkylvinylethers (PAVE) of formula CF₂═CFOR_{f}, wherein R_{f} is a C₁-C₆ (per)fluoroalkyl group, preferably CF₃, C₂F₅, C₃F₇;

(e) (per)fluoro-oxy-alkylvinylethers of formula CF₂═CFOX, wherein X is a C₁-C₁₂ ((per)fluoro)-oxyalkyl comprising catenary oxygen atoms, e.g. the perfluoro-2-propoxypropyl group;

(f) (per)fluorodioxoles having formula (III) above;

(g) (per)fluoro-methoxy-vinylethers (MOVE, hereinafter) having formula: CF₂═CFOCF₂OR_{f2}

wherein R_{f2} is selected from the group consisting of C₁-C₆ (per)fluoroalkyls; C₅-C₆ cyclic (per)fluoroalkyls; and C₂-C₆ (per)fluorooxyalkyls, comprising at least one catenary oxygen atom; R_{f2} is preferably —CF₂CF₃ (MOVE1); —CF₂CF₂OCF₃ (MOVE2); or —CF₃ (MOVE3);

(h) C₂-C₈ non-fluorinated olefins (OI), for example ethylene and propylene; and

(2) TFE-based copolymers, in which TFE is copolymerized with at least one additional comonomer selected from the group consisting of the classes (c), (d), (e), (g), (h) as above detailed, and class (i) below, with the provision that such comonomer is different from TFE:

(i) perfluorovinylethers containing cyanide groups, such as notably those described in patents U.S. Pat. Nos. 4,281,092, 5,447,993 and 5,789,489.

More preferably, the elastomer (E1) is a perfluoroelastomer. The term “perfluoroelastomer” is intended to denote an elastomer substantially free of hydrogen atoms. The expression “substantially free of hydrogen atoms” is understood to mean that the perfluoroelastomer consists essentially of recurring units derived from ethylenically unsaturated monomers comprising at least one fluorine atom and free of hydrogen atoms [per(halo)fluoromonomer (PFM)].

Minor amounts of moieties derived from hydrogen-containing recurring units might be present provided that they do not substantially affect the properties of the perfluoroelastomer. An amount not exceeding 1% moles (preferably not exceeding 0.5% moles) with respect to total moles of per(halo)fluoromonomers (PFM) is generally considered as fulfilling the “perfluoroelastomer” behaviour.

Even more preferably, the elastomer (E1) comprises recurring units derived from TFE and a perfluoroalkylvinylether, said perfluoroalkylvinylether being preferably perfluoromethylvinylether (MVE).

The amount of recurring units derived from said perfluoroalkylvinylether is preferably of at least 25% (mol), more preferably of at least 30% (mol), with respect to total moles of TFE and perfluoroalkylvinylether.

The amount of recurring units derived from said perfluoroalkylvinylether is preferably of at most 40% (mol), more preferably of at most 35% (mol), with respect to total moles of TFE and perfluoroalkylvinylether.

The amount of recurring units derived from TFE is preferably of at least 60% (mol), more preferably of at least 65% (mol), with respect to total moles of TFE and perfluoroalkylvinylether.

The amount of recurring units derived from TFE is preferably of at most 80% (mol), more preferably of at most 70% (mol), with respect to total moles of TFE and perfluoroalkylvinylether.

Said elastomer (E1) may comprise, in addition to recurring units derived from TFE and said perfluoroalkylvinylether, recurring units derived from at least another per(halo)fluoromonomer (PFM).

Should said elastomer (E1) comprise recurring units derived from at least one per(halo)fluoromonomer (PFM) different from TFE and said perfluorovinylether, these recurring units are preferably comprised in an amount not exceeding 5% (mol), more preferably not exceeding 3% (mol), with respect to total moles of recurring units derived from TFE and perfluorovinylether.

Non limitative examples of suitable per(halo)fluoromonomers (PFM) are notably:
perfluoroethylvinylether (EVE);
C₃-C₈ perfluoroolefins, such hexafluoropropene (HFP);
bromo- and/or iodo C₂-C₈ (halo)fluoroolefins, such as bromotrifluoroethylene, iodotrifluoroethylene;
per(halo)fluoroalkylvinylethers complying with general formula CF₂═CFOR_{f3} in which R_{f3} is a C₂-C₆ per(halo)fluoroalkyl, such as —C₂F₅, —C₃F₇, optionally comprising iodine or bromine atoms;
per(halo)fluoro-oxyalkylvinylethers complying with general formula CF₂═CFOX₀₁, in which X₀₁ is a C₁-C₁₂ per(halo)fluorooxyalkyl having one or more ether groups, like perfluoro-2-propoxy-propyl group, optionally comprising iodine or bromine atoms;
per(halo)fluoro-methoxy-alkylvinylethers complying with general formula CF₂═CFOCF₂OR_{f4} in which R_{f4} is a C₁-C₆ per(halo)fluoroalkyl, such as —CF₃, —C₂F₅, —C₃F₇ or a C₁-C₆ per(halo)fluorooxyalkyl having one or more ether groups, such as —C₂F₅—O—CF₃, optionally comprising iodine or bromine atoms;
per(halo)fluorodioxoles of formula (III) above, wherein each of R_{f3}, R_{f4}, R_{f5}, R_{f6}, equal or different from each other, is independently a fluorine atom, a C₁-C₈ per(halo)fluoroalkyl group, optionally comprising one or more oxygen atom, e.g. —CF₃, —C₂F₅, —C₃F₇, —OCF₃, —OCF₂CF₂OCF₃ and optionally comprising iodine or bromine atoms; preferably a per(halo)fluorodioxole complying with formula here above, wherein R_{f3} and R_{f4} are fluorine atoms and R_{f5} and R_{f6} are perfluoromethyl groups (—CF₃) [perfluoro-2,2-dimethyl-1,3-dioxole (PDD)], or a per(halo)fluorodioxole complying with formula here above, wherein R_{f3}, R_{f5} and R_{f6} are fluorine atoms and R_{f4} is a perfluoromethoxy group (—OCF₃) [2,2,4-trifluoro-5-trifluoromethoxy-1,3-dioxole or perfluoromethoxydioxole (MDO)].

Optionally, said elastomer (E1) also comprises recurring units derived from a bis-olefin of general formula (IV) here below:

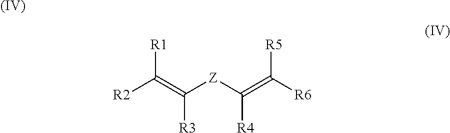

wherein:
R₁, R₂, R₃, R₄, R₅ and R₆, which may be identical or different from each other, are H or C₁-C₅ alkyl;
Z is a linear or branched C₁-C₁₈ alkylene or cycloalkylene radical, optionally containing oxygen atoms, preferably at least partially fluorinated, or a (per)fluoropolyoxyalkylene radical; examples of these bis-olefins are described, for example, in EP 0661304 A (AUSIMONT SPA [IT]) 5 Jul. 1995. Other examples are notably perfluoro-bis-vinyl-ethers.

The amount of recurring units derived from said bis-olefins is generally between 0.01 and 1.0% (mol), preferably between 0.03 and 0.5% (mol), more preferably between 0.05 and 0.2% (mol) with respect to the total moles of recurring units derived from TFE and MVE.

As said, the elastomer (E1) further comprises cure sites.

Preferred elastomers (E1) are those consisting essentially of:
from 60 to 75%, preferably from 65 to 70%, moles of recurring units derived from TFE;
from 25 to 40%, preferably from 30 to 35%, moles of recurring units derived from MVE; and
   further comprising iodine and/or bromine (preferably iodine) as terminal groups of the backbone of the elastomer chain and/or as pending groups bound to said backbone (preferably terminal groups).

Elastomers (E1) suitable for the purpose of the invention can be prepared by any known method, such as emulsion or micro-emulsion polymerization, suspension or micro-suspension polymerization, bulk polymerization and solution polymerization.

### Second Embodiment

In a second embodiment, said at least one polymer (E) is a thermoplastic (per)fluoropolymer. For the sake of clarity, said thermoplastic will be also referred to below as thermoplastic (E2).

As said, in addition to recurring units derived from at least one (per)fluorinated monomer (F) selected from the group identified above, the thermoplastic (E2) may additionally comprise recurring units derived from at least one hydrogenated monomer (M), which is preferably selected from:
ethylene;
acrylic monomers having general formula: CH₂═CH—CO—O—R₂ wherein R₂ is a C₁-C₂₀ hydrocarbon group, optionally containing one or more heteroatoms;
vinylether monomers having general formula: CH₂═CH—O—R₂ wherein R₂ is a C₁-C₂₀ hydrocarbon group, optionally containing one or more heteroatoms;
vinyl esters of the carboxylic acid having general formula: CH₂═CH—O—CO—R₂ wherein R₂ is a C₁-C₂₀ hydrocarbon group, optionally containing one or more heteroatoms;
unsaturated carboxylic acids having general formula CH₂═CH—(CH₂)ₙ—COOH wherein n is 0 or an integer of 1 to 10.

In a preferred embodiment, said thermoplastic (E2) consists essentially of recurring units derived from TFE and at least one (per)fluoroalkylvinylethers of formula CF₂═CFOR_{f1}. Preferably, said (per)fluoroalkylvinylether is perfluoropropylvinylether (PPVE), with R_{f1} being a propyl.

The amount of recurring units derived from TFE preferably ranges from 80 to 99% (mol), more preferably from 90 to 99% (mol), even more preferably from 95 to 98% (mol), with respect to total moles of TFE and (per)fluoroalkylvinylether.

The amount of recurring units derived from said (per)fluoroalkylvinylether preferably ranges from 1 to 20% (mol), more preferably from 1 to 10% (mol), even more preferably from 2 to 5% (mol), with respect to total moles of TFE and (per)fluoroalkylvinylether.

In another embodiment, said thermoplastic (E2) consists essentially of recurring units derived from TFE.

As said, the thermoplastic (E2) further comprises cure sites, preferably iodine cure sites, preferably as terminal groups of the backbone of the polymer chain.

Thermoplastic Polymer [Thermoplastic (P)]

Thermoplastic (P) differs from thermoplastic (E2), particularly in that thermoplastic (P) does not contain cure sites.

Thermoplastic (P) is preferably semi-crystalline.

Said semi-crystalline polymer has a melting point preferably higher than 200° C., more preferably higher than 260° C., even more preferably higher than 280° C., most preferably higher than 300° C., and even higher than 330° C.

According to a first embodiment of the invention, said thermoplastic (P) is fluorinated, that is to say it comprises recurring units derived from at least one (per)fluorinated monomer (F) selected from the group identified above. Said thermoplastic (P) may additionally comprise recurring units derived from at least one hydrogenated monomer (M).

In a preferred embodiment, said thermoplastic (P) consists essentially of recurring units derived from TFE and at least one (per)fluoroalkylvinylethers of formula CF₂═CFOR_{f1}. Preferably, said (per)fluoroalkylvinylether is perfluoromethylvinylether (MVE), wherein R_{f1} is CF₃.

The amount of recurring units derived from TFE preferably ranges from 80 to 99% (mol), more preferably from 90 to 99, even more preferably from 95 to 98%, with respect to total moles of TFE and (per)fluoroalkylvinylether.

The amount of recurring units derived from said (per)fluoroalkylvinylether preferably ranges from 1 to 20% (mol), more preferably from 1 to 10% (mol), even more preferably from 2 to 5% (mol), with respect to total moles of TFE and (per)fluoroalkylvinylether.

Thermoplastic (P) consisting of recurring units derived from TFE and the (per)fluoroalkylvinylether possesses a melting point exceeding 200° C., preferably exceeding 260° C., more preferably exceeding 270° C., even more preferably exceeding 280° C. The melting temperature is determined by Differential Scanning Calorimetry (DSC) at a heating rate of 10° C./min, according to ASTM D 3418.

In another embodiment, said thermoplastic (P) consists essentially of recurring units derived from TFE.

According to a second embodiment of the invention, said thermoplastic (P) is non-fluorinated, that is to say it comprises recurring units derived from fluorine-free monomer(s).

Preferably, said thermoplastic (P) is an aromatic polymer.

According to a preferred embodiment, said aromatic polymer is a poly(arylene sulphide) (PAS). A PAS comprises recurring units (R_{PAS}) of formula —(Ar—S)— as the main structural units, preferably in an amount of at least 80% (mol), wherein Ar is an aromatic group. Examples of Ar include groups of formulas (V-A) to (V-K) given below:

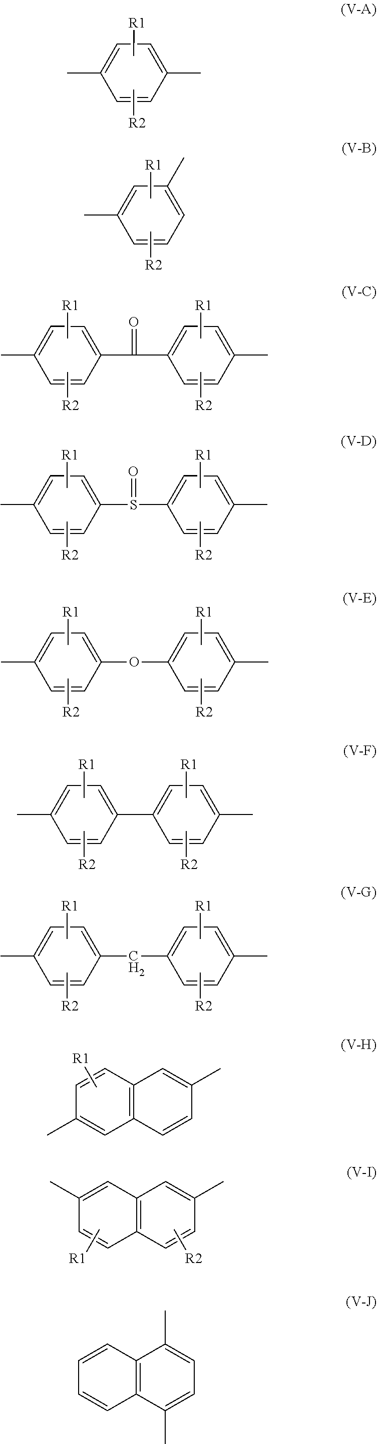

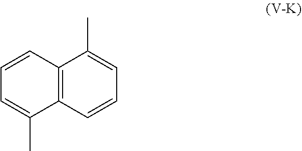

wherein R1 and R2, equal or different from each other, are independently selected among hydrogen atoms, alkyl of 1 to 12 carbon atoms, alkoxy of 1 to 12 carbon atoms, arylene of 6 to 24 carbon atoms, and halogens.

PAS preferably comprises recurring units (R_{PAS}) in which Ar is a group of formula (V-A), more preferably in which R1 and R2 are hydrogen atoms. Accordingly, PAS is preferably a poly(phenylene sulphide) (PPS), which is notably available as RYTON® PPS from Solvay Specialty Polymers USA, L.L.C.

According to another embodiment, said aromatic polymer is an aromatic sulfone polymer (SP). For the purposes of the present invention, the definition “aromatic sulfone polymer (SP)” is intended to denote any polymer of which more than 50% (wt), preferably more than 70% (wt), more preferably more than 90% (wt), of recurring units (R_{SP}) comprise at least one group of formula (VI):

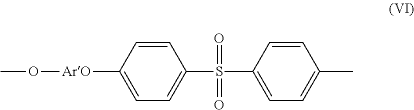

wherein Ar′ is a group chosen among the following structures:

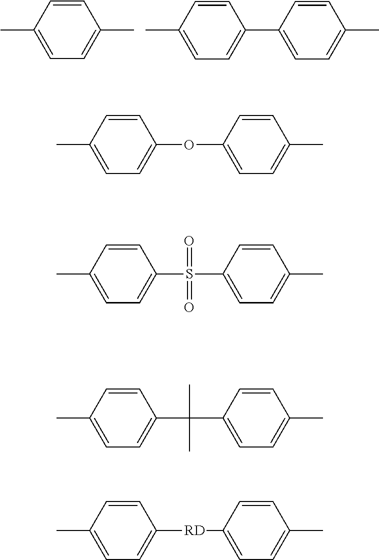

with R_{D} being selected among:

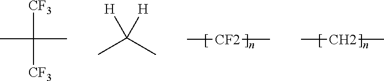

with n being an integer from 1 to 6.

The recurring units (R_{SP}) are preferably chosen from:

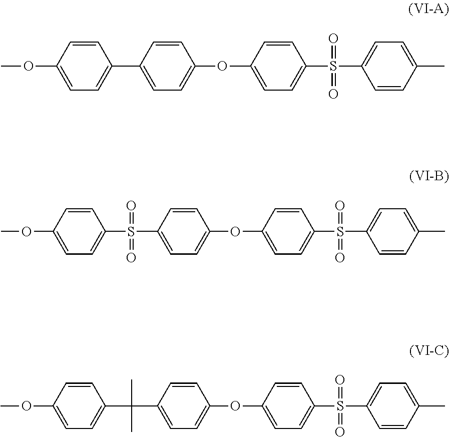

Accordingly, the aromatic sulfone polymer (SP) is preferably chosen among the group consisting of: polysulfone (PSU), polyphenylsulfone (PPSU), polyethersulfone (PESU), copolymers and mixtures thereof, and is most preferably a polysulfone (PSU) or polyphenylsulfone (PPSU).

Polysulfone (PSU) is notably available as UDEL® PSU from Solvay Specialty Polymers USA, L.L.C and is made by condensing bisphenol A and 4,4′-dichlorodiphenyl sulfone.

Polyphenylsulfone (PPSU) is notably available as RADEL® R from SOLVAY ADVANCED POLYMERS, L.L.C and is made by reacting units of 4,4′-dichlorodiphenyl sulfone and 4,4′-biphenol.

According to another preferred embodiment, said aromatic polymer is a poly(ether ether ketone) (PEEK). The definition “poly(ether ether ketone) (PEEK)” is intended to denote any polymer of which at least 50% (mol) of recurring units (R_{PEEK}) are recurring units of formula (VII):

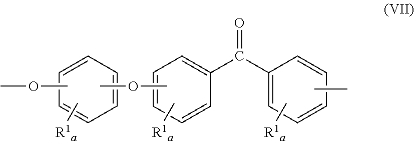

based on the total number of moles of recurring units in the PEEK, wherein:
each R¹, equal or different from each other, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each a, equal to or different from each other, is independently selected from 0, 1, 2, 3, and 4. Preferably, each a is 0.

Preferably at least 60% (mol), at least 70% (mol), at least 80% (mol), at least 90% (mol), at least 95% (mol), or at least 99% (mol) of the recurring units (R_{PEEK}) are recurring units of formula (VII).

Preferably, the phenylene moieties in recurring units (R_{PEEK}) have 1,3- or 1,4-linkages.

In some embodiments, more than 50% (mol) of recurring units (R_{PEEK}) are recurring units of formula (VII-A):

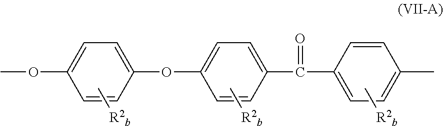

where each R² and b, at each instance, is independently selected from the groups described above for R¹ and a, respectively. b in formulae (A-1) is an integer ranging from 0 to 4, preferably 0.

Preferably at least 60% (mol), at least 70% (mol), at least 80% (mol), at least 90% (mol), at least 95% (mol) or at least 99% (mol) of recurring units (R_{PEEK}) are recurring units of formula (VII-A). Said PEEKs are notably available as KetaSpire® KT-820 or KetaSpire® KT-880 from Solvay Specialty Polymers USA, L.L.C.

Curable Composition

The curable composition of the invention comprises said at least one agent (C) in an amount preferably of at least 0.1% (wt), more preferably of at least 1% (wt), and preferably of at most 10% (wt), more preferably of at most 4% (wt), with respect to the total weight of the composition.

Said composition comprises said at least one polymer (E), being it the elastomer (E1) or the thermoplastic (E2), in an amount preferably of at least 10% (wt), more preferably of at least 25% (wt), even more preferably of at least 35% (wt), and preferably of at most 90% (wt), more preferably of at most 75%, even more preferably of at most 45% (wt), with respect to the total weight of the composition.

According to various embodiments of the invention, said composition comprises at least one elastomer (E1), or at least one thermoplastic (E2), or a combination thereof.

Said composition comprises said at least one thermoplastic (P) in an amount preferably of at least 10% (wt), more preferably of at least 60% (wt), and preferably of at most 90% (wt), more preferably of at most 70% (wt), with respect to the total weight of the composition.

According to a preferred embodiment, said composition comprises at least one metal oxide or hydroxide, more preferably MgO. Said at least one metal oxide or hydroxide advantageously promotes the cross-linking of the polymer (E).

Accordingly, said composition comprises said at least one metal oxide or hydroxide in an amount preferably of at least 0.1% (wt), more preferably of at least 1% (wt), and preferably of at most 10% (wt), more preferably of at most 4% (wt), with respect to the total weight of the composition.

Blend

As said, the present invention also relates to a method for manufacturing a blend comprising a continuous thermoplastic polymer phase and a dispersed vulcanized polymer phase, said method comprising dynamic curing of the curable composition identified above.

The dynamic curing procedure is well known to a person skilled in the art and includes heating the composition in an extruder or a mixer at a temperature at which both the thermoplastic (P) and the polymer (E) are in their molten state, that is above their respective glass transition or melting temperatures whatever is the highest, and vulcanizing the polymer (E) while exerting a mixing shearing force. According to the method of the present application, said temperature is preferably at least 300° C., more preferably at least 320° C., even more preferably at least 350° C.

Dynamic vulcanization can be performed using standard mixing devices, preferably using extruder devices, with twin-screw extruders being preferred. An example of dynamic curing procedure is disclosed in WO2015/014698 (Solvay Specialty Polymers Italy S.P.A.) 5 May 2015.

According to the method of the invention, ingredients of the composition can be pre-mixed all together and fed to the extruder e.g. through a single hopper, or can be fed to the extruder through separated feeders. It is generally preferred to add a masterbatch comprising the polymer (E), the agent (C) and, if present, the metal oxide or hydroxide, through a separate feeder, which will deliver said masterbatch in the molten mass of the thermoplastic (P).

As a result of the dynamic curing procedure, said polymer (E) is at least partially chemically cross-linked. If referred to a (per)fluoroelastomer, the expression “partially chemically cross-linked” is intended to denote that the polymer (E) is cross-linked to such an extent that it retains elastomeric properties.

Said blend is commonly termed thermoplastic vulcanizate (TPV) if the dispersed phase is elastomeric.

As said, the present invention also relates to a method for manufacturing a shaped article, said method comprising moulding said blend. The technique used for moulding is not particularly limited; standard techniques including shaping the blend in a molten/softened form can be advantageously applied, and include notably compression moulding, extrusion moulding, injection moulding, transfer moulding and the like.

The blend according to the present invention has several advantages, for example: good mechanical properties, notably in terms of ductility and flexibility, a broad temperature range of application, and notable thermal-chemical resistance. Therefore, said blend can be suitably used in various fields including automotive, oil and gas, electric and electronics. Particularly, said blend can be advantageously used for manufacturing films, sheets and wire coatings having excellent mechanical and electrical performances, and for injection moulding or extrusion of flexible parts retaining outstanding chemical resistance.

Should the disclosure of any patents, patent applications, and publications which are incorporated herein by reference conflict with the description of the present application to the extent that it may render a term unclear, the present description shall take precedence.

The invention will now be described with reference to the following examples, whose purpose is merely illustrative and not intended to limit the scope of the invention.

### EXPERIMENTAL SECTION

Materials

Curing agent of formula (II-1), hereinafter referred to as BODA, was prepared following the general procedure described in Smith, D. W., Babb, D. A.; J. Am. Chem. Soc. 120, n. 35, (1998) 9078-9079.

TECNOFLON® FFKM PFR94 is a TFE/MVE perfluoroelastomer containing iodine, commercially available from Solvay Specialty Polymers Italy.

HYFLON® MFA 640 is a TFE/MVE thermoplastic polymer with a melting point of 285° C., commercially available from Solvay Specialty Polymers Italy.

RYTON® QA200N is a medium-high viscosity PPS with a melting point of 285° C. and is commercially available from Solvay Specialty Polymers USA.

KetaSpire® KT-880 is a low viscosity PEEK with a melting point of 340° C. and is commercially available from Solvay Specialty Polymers USA.

MgO is commercially available as Maglite-DE® from Hallstar.

Luperox 101 XL 45 is commercially available from Arkema.

Drimix 75% TAIC is commercially available from Finco s.r.l.

Methods

Tensile Measurements

Tensile measurements were performed according to ASTM D638 with the specimen V at 23° C. and with a deformation speed of 10 mm/min.

SEM Analyses

SEM images were obtained by Cambridge SEM 200 scanning electron microscope. The images refer to the surfaces obtained by cryo-fracturing 1 mm thick films from compression moulding.

Photographic Analyses

The photographic analyses were performed on 1 mm thick films from compression molding using the photocamera of a Samsung J6 mobile phone.

### SYNTHESIS EXAMPLES

Synthesis of Masterbatch A

FFKM PFR 94 (100 g) was mixed with BODA (3 g) and MgO (3 g) at ambient temperature in a Brabender 50 EHT internal mixer using Banbury blades at 10 rpm for 30 minutes. The mixer was cooled with compressed air. The thus obtained masterbatch A was removed from the mixer and finely cut for the synthesis of TPVs according to the examples 1, 2 and 3 (E1 to E3).

### Example 1 (E1): Preparation of a Blend Comprising MFA 640 and the Masterbatch A

MFA 640 (19.5 g) was poured into a Brabender 50 EHT internal mixer using Roller blades and melted for 10 minutes at 30 rpm. Then, the masterbatch A (45.5 g) was added and mixed at 30 rpm for 20 min. A TPV was obtained. The so obtained TPV was manually removed from the mixer, finely cut and subsequently compression molded in a 1 mm thick film to obtain a sample for tensile measurements, photographic analysis and SEM analysis.

### Example 2 (E2): Preparation of a Blend Comprising Ryton® QA200N and the Masterbatch A

Ryton® QA200N (19.5 g) was poured into a Brabender 50 EHT internal mixer using Roller blades and melted for 10 minutes at 30 rpm. Then, the masterbatch A (45.5 g) was added and mixed at 30 rpm for 20 min. A TPV was obtained. The so obtained TPV was manually removed from the mixer, finely cut and subsequently compression molded in a 1 mm thick film to obtain a sample for tensile measurements, photographic analysis and SEM analysis.

### Example 3 (E3): Preparation of a Blend Comprising KetaSpire® KT-820 and the Masterbatch A

KetaSpire® KT-880 (16.5 g) was poured into a Brabender 50 EHT internal mixer using Roller blades and melted for 10 minutes at 30 rpm. Then, the masterbatch A (38.5 g) was added and mixed at 70 rpm for 10 min. A TPV was obtained. The so obtained TPV was manually removed from the mixer, finely cut and subsequently compression molded in a 1 mm thick film to obtain a sample for tensile measurements, photographic analysis and SEM analysis.

Synthesis of Masterbatch B

FFKM PFR 94 (100 g) was mixed with Luperox 101 XL45 (3 g), Drimix 75% TAIC (4 g) and MgO (3 g) at ambient temperature in a Brabender 50 EHT internal mixer using Banbury blades at 10 rpm for 30 minutes. The mixer was cooled with compressed air. The thus obtained masterbatch B was removed from the mixer and finely cut for the synthesis of TPV according to comparative example 4 (CE 4).

Comparative Example 4 (CE 4): Preparation of a Blend Comprising MFA and the Masterbatch B

MFA 640 (19.5 g) was poured into a Brabender 50 EHT internal mixer using Roller blades and melted for 10 minutes at 30 rpm. Then, the masterbatch B (45.5 g) was added and mixed at 30 rpm for 20 min. The so obtained mixture was manually removed from the mixer, finely cut and subsequently compression molded in a 1 mm thick film to obtain a sample for tensile measurements, photographic analysis and SEM analysis.

Properties of Blends According to the Invention

Table 1 reports the mechanical properties of the TPV samples according to examples 1, 2 and 3 (E1, E2 and E3), namely the strain at break, the yield strength, the stress at break, the tensile modulus and the storage modulus at 200° C. Table 1 also reports the strain at break, the yield strength, the stress at break and the tensile modulus of the sample according to the comparative example 4 (CE4)

TABLE 1

| | E1 | E2 | E3 | CE4 |
|---|---|---|---|---|
| Modulus [MPa] | 31 | 45 | 330 | 27 |
| Yield strength [MPa] | 1.4 | 1.4 | 7 | 1.8 |
| Stress at break [MPa] | 5 | 5 | 10.8 | 7.7 |
| Strain at break [%] | 235 | 45 | 18 | 117 |
| Storage Modulus at | 2 | 2.5 | 40 | — |
| 200° C. [MPa] | | | | |

By a comparison of the mechanical properties of the samples according to E1 and CE4—both comprising MFA 640 as the thermoplastic polymer—it is interestingly noted that the sample according to E1 exhibits significantly greater flexibility and ductility (i.e. greater strain at break), while showing slightly lower strength and stiffness (i.e. lower yield strength and stress at break). It is, therefore, interestingly noted that the sample according to E1 shows a good balance between strength, stiffness, flexibility and ductility.

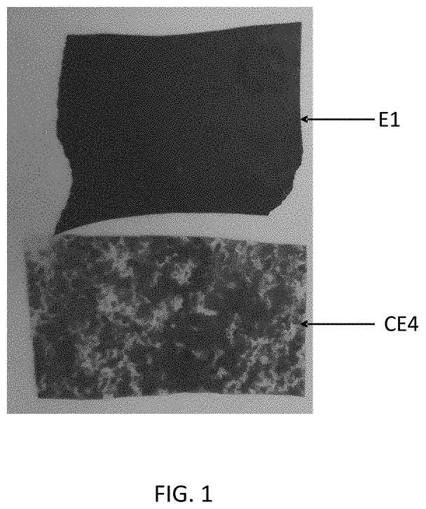

The sample according to E1 also ensures a significantly better dispersion of the dispersed phase (PFR 94) in the thermoplastic matrix (MFA 640) than the sample according to CE4, as evident from FIGS. 1 to 3.

More in detail, referring to the images from the photographic analysis of FIG. 1, it is observed that the sample according to E1 is clearly homogeneous, contrary to the sample according to CE4 which comprises transparent portions (corresponding to MFA 640) and brown portions as well (corresponding to PFR 94).

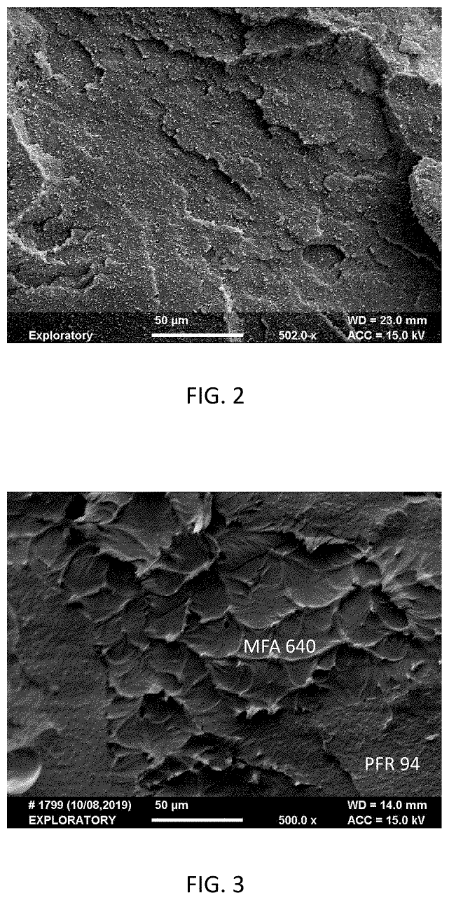

The SEM micrographs of the samples according to E1 and CE4, reported in FIGS. 2 and 3 respectively, show two distinct phases, namely a semi-crystalline phase corresponding to MFA 640 and an amorphous phase corresponding to PFR 94. Referring to FIG. 2, the black domains are the ones corresponding to PFR 94 and the white domains are the ones corresponding to MFA 640. Referring to FIG. 3, the smooth-looking phase domains are the ones corresponding to PFR 94, while the rough-looking phase domains are the ones corresponding to MFA 640. While in the sample shown in FIG. 2 the PFR 94 phase and the MFA 640 phase are finely intermixed thus providing a homogenous blend, in the sample shown in FIG. 3 there is not a fine dispersion of one phase into the other and the blend has a much coarser morphology.

1-17. (canceled)

18. A curable composition comprising:
(a) at least one polymer comprising cure sites [polymer (E)];
(b) at least one thermoplastic polymer [thermoplastic (P)] different from said polymer (E),
(c) at least one curing agent [agent (C)] of formula (I): 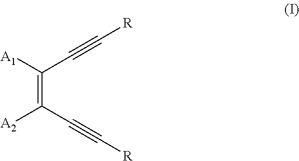
wherein:
each R, equal to or different from each other, is independently selected from the group consisting of hydrogen; halogen; C₁-C₂₀ alkyl, linear or branched, optionally substituted and/or optionally fluorinated; C₁-C₂₀ oxyalkyl, linear or branched, optionally substituted and/or optionally fluorinated; (per)fluoropolyether chain; aromatic or heteroaromatic radical, monocyclic or polycyclic, optionally substituted and/or optionally fluorinated; —SiR¹₃, —(R¹₂SiO)_{b}R¹, —PR¹₂ wherein each R¹, equal to or different from each other, is independently selected from the group consisting of hydrogen, C₁-C₂₀ alkyl, linear or branched, optionally substituted and/or optionally fluorinated and wherein b is an integer of at least 1; and
A₁ and A₂, equal to or different from each other, are each independently selected from the group consisting of hydrogen; halogen; C₁-C₂₀ alkyl, linear or branched, optionally substituted and/or optionally fluorinated; C₁-C₂₀ oxyalkyl, linear or branched, optionally substituted and/or optionally fluorinated; (per)fluoropolyether chain; —(R¹₂SiO)_{b}R¹ wherein R¹ and b are as defined; aromatic or heteroaromatic radical, monocyclic or polycyclic, optionally substituted and/or optionally fluorinated.

19. The composition according to claim 18, comprising at least one metal oxide or hydroxide.

20. The composition according to claim 18, wherein the curing agent is selected from the group of compounds of formula (II): 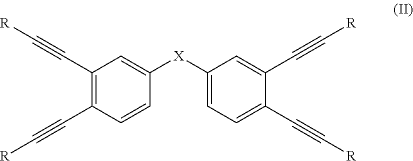
wherein each R, equal to or different from each other, is as defined above and wherein X is a divalent bridging group selected from a carbon-carbon bond; a C₁-C₂₀ alkylene radical, optionally substituted and/or optionally fluorinated; a divalent (per)fluoropolyether radical; an organopolysiloxane radical —(R¹₂SiO)_{b}— wherein R¹ and b are as defined above; a —O— radical; a —S— radical; a —SO₂— radical; a —C(O)— radical; a fused aromatic or heteroaromatic structure optionally substituted and/or optionally fluorinated; X being preferably a fluorinated C₁-C₂₀ alkylene radical, preferably —C(CF₃)₂— or —(CF₂)ₙ— wherein n is an integer from 1 to 20, e.g. 2, 3, 4, 6, 8, 10, 12, 14, 16, 18, 20.

21. The composition according to claim 18, wherein said polymer (E) comprises iodine and/or bromine cure sites.

22. The composition according to claim 18, wherein said at least one polymer (E) is a (per)fluoroelastomer.

23. The composition according to claim 22, wherein said at least one polymer (E) comprises recurring units derived from tetrafluoroethylene (TFE) and recurring units derived from at least one perfluoroalkylvinylether.

24. The composition according to claim 23, wherein the amount of the recurring units derived from said perfluoroalkylvinylether is either from 25% (mol) to 40% (mol), with respect to total moles of TFE and the perfluoroalkylvinylether, or from 60% (mol) to 80% (mol), with respect to total moles of TFE and the perfluoroalkylvinylether.

25. The composition according claim 18, wherein said at least one polymer (E) is a thermoplastic (per)fluoropolymer comprising recurring units derived from tetrafluoroethylene (TFE) and recurring units derived from at least one (per)fluoroalkylvinylether.

26. The composition according to claim 25, wherein the amount of the recurring units derived from TFE preferably ranges from 80 to 99% (mol), with respect to the total moles of TFE and the (per)fluoroalkylvinylether, and/or wherein the amount of recurring units derived from said (per)fluoroalkylvinylether ranges from 1 to 20% (mol), with respect to the total moles of TFE and the (per)fluoroalkylvinylether.

27. The composition according to claim 18, said thermoplastic (P) being semi-crystalline and having a melting temperature higher than 200° C.

28. The composition according to claim 18, wherein said thermoplastic (P) is fluorinated and comprises recurring units derived from tetrafluoroethylene (TFE) and recurring units derived from at least one (per)fluoroalkylvinylether, wherein the amount of the recurring units derived from TFE ranges from 80 to 99% (mol), with respect to the total moles of TFE and the (per)fluoroalkylvinylether, and/or wherein the amount of recurring units derived from said (per)fluoroalkylvinylether ranges from 1 to 20% (mol), with respect to the total moles of TFE and the (per)fluoroalkylvinylether.

29. The composition according to claim 18, wherein the thermoplastic (P) is an aromatic polymer.

30. The composition according to claim 29, wherein said thermoplastic (P) is a poly(arylene sulphide) (PAS) comprising recurring units of formula —(ArS)—, Ar being an aromatic group.

31. The composition according to claim 29, wherein said thermoplastic (P) is a poly(ether ether ketone) (PEEK) comprising recurring units of formula (VII-A): 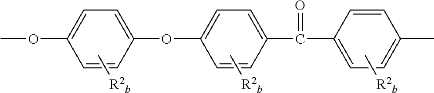
wherein each R², equal or different from each other, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each b, equal to or different from each other, is independently selected from 0, 1, 2, 3, and 4, being preferably 0.

32. The composition according to claim 18, wherein:
the amount of said at least one agent (C) is of at least 0.1% (wt), and of at most 10% (wt), with respect to the total weight of the composition; and/or
the amount of said at least one polymer (E) is of at least 10% (wt), and of at most 90% (wt), with respect to the total weight of the composition; and/or
the amount of said at least one thermoplastic (P) is of at least 10% (wt), and of at most 90% (wt), with respect to the total weight of the composition.

33. A method for manufacturing the composition according to claim 18, said method comprising at least one step of mixing said at least one polymer (E), said at least one agent (C) and said at least one thermoplastic (P).

34. A method for manufacturing a blend comprising a continuous thermoplastic polymer phase and a dispersed vulcanized polymer phase, said method comprising dynamic vulcanizing the composition according to claim 18.

35. A blend comprising a continuous thermoplastic polymer phase and a dispersed vulcanized polymer phase, said blend being obtained by the method according to claim 34.

36. A method for manufacturing a shaped article, said method comprising moulding the blend of claim 35.
